(19) United States
(12) Patent Application Publication
(10) Pub. No.: US 2018/0247079 A1
(43) Pub. Date: Aug. 30, 2018

(54) METHOD AND SYSTEM FOR ACTIVATING USER CONTEXTS ACCORDING TO ONLINE SERVICE USE

(71) Applicant: PCMS Holdings, Inc., Wilmington, DE (US)

(72) Inventor: Ville J. Ollikainen, Vihti (FI)

(21) Appl. No.: 15/756,027

(22) PCT Filed: Aug. 17, 2016
(86) PCT No.: PCT/US16/47437

§ 371 Date: Feb. 27, 2018

Related U.S. Application Data
(60) Provisional application No. 62/211,563, filed on Aug. 28, 2015.

(51) Int. Cl. G06F 21/62; H04L 9/08; H04L 29/06

(52) U.S. Cl. CPC G06F 21/6263; H04L 65/1083; H04L 9/088; H04L 9/0866

(57) ABSTRACT

Exemplary systems and methods enable consistent context settings for different devices of a user. When a user accesses a service such as a web site through a user device, the device determines whether the service has previously-stored context information associated with a user of the device. If the service does not have previously-stored context information associated with that user, the user device sends context information to service identifying a current context setting of the user device. If the networked service does have previously-stored context information associated with the user, the user device receives that information and switches the context of the device to a context identified by the previously-stored context information.

### CROSS-REFERENCE TO RELATED APPLICATION

The present application is a non-provisional filing of, and claims benefit under 35 U.S.C. § 119(e) from, U.S. Provisional Patent Application Ser. No. 62/211,563, entitled “Method and System for Activating User Contexts According to Online Service Use”, filed Aug. 28, 2015, the entirety of which is incorporated herein by reference.

### BACKGROUND

The equipment people are carrying is becoming increasingly versatile. Not long ago, a mobile phone was commonly used merely for voice and SMS communications, whereas nowadays a mobile phone has computing power of a previous-generation laptop, not to mention a myriad of sensors, including satellite navigation receivers and acceleration sensors.

Individuals use mobile computing devices such as smartphones during many different activities and for different roles in each activity. In current systems, information is generally shared among different activities and circumstances in ways that are beyond a user's control. For example, a user who is secretly shopping for a gift for his spouse may believe that he his shopping in secret. However, his shopping activity may be tracked, for example with the use of HTTP cookies. Then when he visits, for example, a social media website along with his spouse, there is a risk that the social media website will display an advertisement for the very gift he was hoping to keep secret. While HTTP cookies and other forms of tracking can be disabled, doing so greatly diminishes the functionality of online services.

### SUMMARY

Different personal data may be relevant to different contexts, and users may not want data from one context to be available to applications when the user is in a different context. Such cross-context data availability can create privacy risks and inconveniences. Embodiments disclosed herein enable context-based protection of personal data and automatic context switching in response to connection with online services.

Embodiments disclosed herein operate to enable a user to provide context information to a service, such as a web site, identifying the context in which the service was activated. The service returns the context information to the user in a subsequent session, which may be conducted on a different user device or terminal. In response to the context information, the user device reactivates the corresponding context setting in which the service was initially activated.

In an exemplary method, a user accesses a networked service, such as a web site, with a first user device. The first user device sends to the networked service context information identifying a current first context of the first user device. Subsequently, the user accesses the networked service with a second user device, which may initially be in a second context different from the first context. In response to accessing the networked service with the second user device, the second user device receives the context information. In response to receiving the context information, the context of the second user device is switched from the second context to the first context identified in the received context information. The different contexts may be associated with different data access permissions.

### BRIEF DESCRIPTION OF THE DRAWINGS

FIG. 1 is a schematic illustration of a system architecture employed in some embodiments.

FIG. 2 is an exemplary sequence diagram illustrating an example message exchange in a situation in which context information is not available from a context-information-enabled service.

FIG. 3 is an exemplary sequence diagram illustrating an example message exchange in a situation in which context information is available from a context-information-enabled service.

FIG. 4 is a schematic illustration of an exemplary user device architecture employing a plurality of context modules.

FIG. 5 illustrates an exemplary wireless transmit/receive unit (WTRU) that may be employed as a user device in some embodiments.

FIG. 6 illustrates an exemplary network entity that may be employed as a networked service provider, such as a web server, in some embodiments.

### DETAILED DESCRIPTION

A computing device may provide support for different contexts by providing different user interfaces for different contexts and by providing context-based personal data protection by context. To explain the concept of a context with sensitive data, consider an exemplary user who is a casual gambler. The user is not interested in sharing this hobby with anyone else, except perhaps other gamblers. He is also an active social media user, he likes to watch movies, he goes to work every day, and he keeps every now and then electronic record of his health. In this example there are already five different contexts: work (e.g. named “MyWork”), movies (“MyMovies”), social networking (“MyFriends”), gambling (“MyPoker”) and health (“MyHealth”). In a context-enabled computing device, items of personal data are associated with one or more contexts, and the data protections for those items of personal data are determined based on the context or contexts with which the item of data is associated. Different context settings may be used to define different protections for associated data.

Technologies are available that protect mobile devices from unauthorized use, amounting to switching from no context to some personal context. For instance, PIN codes, passwords and gestures, as well biometric authentication, such as fingerprint scanning or walking style, are used to allow access to mobile device use. While the access to the mobile device has been granted, typically all data is available for the user without restrictions. As a consequence, security measures for personal data protection may be built into individual services.

Personal computing devices, such as smart phones, tablets and even smart watches may have different views into which organize different applications. These applications, however, access the data in the device (or cloud) uniformly, not depending on the context the user is in. Thus, a user may unintentionally disclose sensitive data actually belonging to context A (say, health) when launching an application when in context B (say, a social network service upload), not to mention malware, which may deliberately breach personal information.

Some launcher applications, such as Aviate by Yahoo, organize applications according to contexts, but they do not provide solutions for data protection.

In another scenario for a context-related user interface (UI), Google Now cards, the service provider Google collects personal data and tracks the use of the cards. Thus, this scenario does not address context specific personal data protection at all. From a UI perspective, there is also lack of transparency, such that users may be unaware why any particular card is presented to the user.

HomeKit and HealthKit systems from Apple operate to protect home and health related data, but they do not in general provide support for user contexts.

In personal computing, users may organize applications, bookmarks and shortcuts into different folders. Data in different folders may have different security measures. However, applications have access according to user account preferences, not according to folders.

In the “BYOD” (Bring Your Own Device) paradigm, people have their own devices, while data is owned by a third party (e.g. employer). There may be multiple user accounts in a device, one for work, and other for private use. Such solutions, however, do not allow data within each application (for instance a typical built-in calendar) to be divided into different contexts (work, team, private, family).

Desktop/laptop operating systems, as well as Android versions from 4.2 on, have multiple user logins, with different users having different data storage areas and different access profiles. A user may configure several accounts for different contexts with the accounts representing contexts. Fast user switching may make such a methodology quite convenient. However, in this case, different user accounts are separate; for example, they do not have common user names, addresses, and credentials and they do not provide any easy means for context change, related to the ease of launchers.

In exemplary embodiments disclosed herein, any device may have a plurality of user accounts, and each user account may support a plurality of contexts.

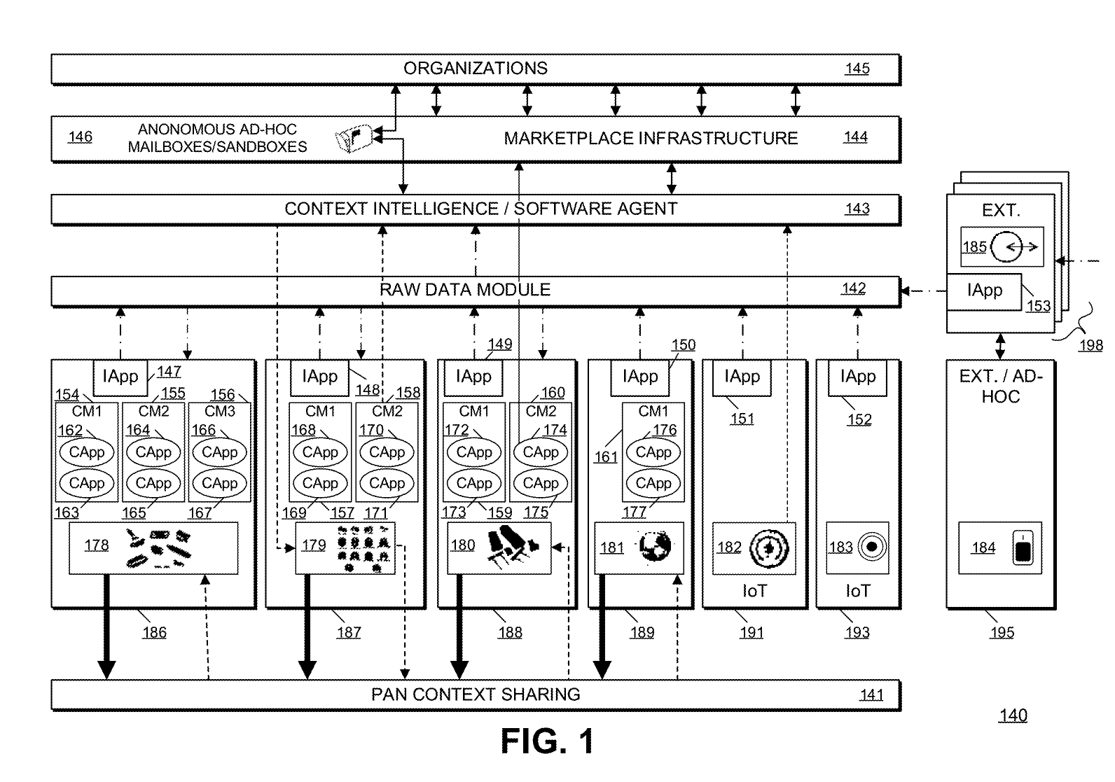

In some embodiments, a user has multiple contexts, which may be selected on a plurality of devices. The devices are capable of accessing personal information from a common repository for one or more personal area network (PAN) devices. For example, FIG. 1 illustrates an architecture 140 in which a user has a myriad of devices such as a music player 186, a smart phone 187, a smart watch 188, and a smart vehicle 189 capable of maintaining the user's personal information at a cloud service. In such an embodiment 140, the personal information that is available to PAN devices 186, 187, 188, 189 at a given time depends on context. The PAN devices 186, 187, 188, 189 are capable of sharing context information over a personal area network, and when one device changes context, the accompanying devices switch context accordingly.

The embodiment 140 illustrated in FIG. 1 may allow for sensors 178, 179, 180, 181, 182, 183 to update a personal data repository, advantageously common to a plurality of devices, a raw data module 142, hereinafter referred to as “common repository”. Given that personal data in the common repository may relate to a user's location, the user's personal location may be updated by the device in which a respective sensor is active. The common repository 142 may also contain context settings for different contexts.

In FIG. 1, sensor control communications are shown as dashed lines, with arrows indicating example directions. Exchanges of context information are shown in FIG. 1 as thick, solid arrows. Communications involving personal information are shown in FIG. 1 as dash-dot lines with arrows. As shown in FIG. 1, devices 186, 187, 188, 189, 191, 193, 195, 198 may comprise an input application (IApp) 147, 148, 149, 150, 151, 152, 153, one or more context modules (CMs) 154, 155,156, 157, 158, 159, 160, 161, and one or more sensors 178, 179, 180, 181, 182, 183, 184, 185. In some embodiments, an IApp 147, 148, 149, 150, 151, 152, 153 may exchange personal information with a raw data module 142. Context modules 154, 155, 156, 157, 158, 159, 160, 161 may contain a context application (CApp) 162, 163, 164, 165, 166, 167, 168, 169, 170, 171, 172, 173, 174, 175, 176, 177.

In some embodiments, each device 186, 187, 188, 189 in the PAN 141 has multiple sensors 178, 179, 180, 181. Providing sensor data to third parties or storing sensor data to the common repository 142 may be enabled or disabled on a per-sensor basis depending on the context settings of the current context. In general, the more sensor data available to a given PAN device, the better the context detection by the device. Accordingly, to facilitate more-reliable context changes by other PAN devices, a given PAN device 186, 187, 188, 189 may exchange sensor data with another PAN device 186, 187, 188, 189 even though access to that sensor data in a common repository 142 would otherwise be restricted based on a current context. Sensor data may be shared within the PAN even when providing the data is disabled, in order to determine context changes more reliably. The given PAN device 186, 187, 188, 189 may thereafter exclude the sensor data from any exchanges of context information with other PAN devices 186, 187, 188, 189. Context change may depend on sensor data from multiple devices.

In some embodiments, sensor data (in addition to or instead of context control) is shared in the PAN 141 before sensor visibility is selected. Both sensor and context data may be shared before selecting sensor visibility. For some embodiments, PAN context sharing 141 may be implemented using the Bluetooth protocol.

In some embodiments, the PAN devices 186, 187, 188, 189 are capable of updating personal information in a common repository 142. The update depends on the context (as described below). The personal information may include sensor data obtained by one or more of the PAN devices 186, 187, 188, 189. For example, personal information may include a location detected by a Global Positioning System (GPS) receiver 181 of a given PAN device 189. Access to personal information and/or updates to personal information (e.g., by an application executed by a PAN device 186, 187, 188, 189) may be permitted or restricted based on a current context.

FIG. 1 shows a set of organizations 145 that communicate with an intermediary labeled as marketplace infrastructure 144. The marketplace 144 may include anonymous ad-hoc mailboxes 146. The marketplace 144 and anonymous ad-hoc mailboxes 146 communicate with context intelligence or user agent labeled as the software agent 143.

In embodiments disclosed herein, a computing device 186, 187, 188, 189 automatically selects a context based on a service being contacted by a computing device. Certain online services, or portions of services, are related to certain contexts.

A context-enabled user computing device 186, 187, 188, 189 sends a message containing context information (hereinafter referred to as “context information”, or “CI”) to an online service that is currently in use. The service stores the context information, and upon a subsequent request, returns the information back to a user device. The user device (and, in some embodiments, accompanying devices) switches to the context identified in the context information sent by the service. In some embodiments, the user is informed when context switching takes place.

When the user stops using the service, the previous context may be re-activated. Determination of when the user stops using the service is described below.

In an exemplary embodiment, the processes of sending the context information and of requesting the context information includes presentation of a unique identifier of the user, a “user ID”. Both the user identifier and the context information may be random numbers, for instance in UUID v4 format. In some embodiments, the context information is a random number that is used to identify particular context settings, where an association between the context information and the settings may be stored in the common repository. In some embodiments, different user identifiers are used on different sites to prevent cross-site tracking of users. A user identifier may be information calculated from other identifying information of a user, for example, a user identifier may be the outcome of a hash function applied to a combination of the user's email address, the URL or portion thereof (e.g. domain name) of a site being visited, and one or more other values that are kept secret by the user but that can be used for reliable calculation of site-specific user identifiers.

In some embodiments, the user ID is advantageously calculated using a cryptographic function after combining a unique service identifier (such as www domain name) and a user specific secret (main) key. An example of such a cryptographic function is a keyed-hash message authentication code (HMAC). The secret key is advantageously stored in a user specific personal repository, a common repository such as a raw data module described above.

In this embodiment, the user ID remains the same each time the user visits the domain. Thus the service has more reliable identification of the user, even when the service is used anonymously. When a service may keep track of anonymous users, a service may substantially help usage analytics.

As a further advantage of this embodiment, even though the user is likely to visit several services, the user ID is different in each service, making difficult the tracing of a user from one service (which may use authentication) to another (which may be anonymous).

Embodiments disclosed herein provide an improved user experience by operating in the background operation while still being transparent and easily understood. In exemplary embodiments, the user device is capable of presenting different views for different contexts, for ease of use.

An exemplary implementation uses browser software, installed as an add-on or a plugin module. The online service may include a tag in its page sources informing that the online service is capable of storing context information (a “CI enabled” tag). When the plugin detects the tag, the plugin requests previously stored context information. If there is no previously-stored context information for that user at that online service, the user device sends the service the current context information, if that information is available to the current device.

In some embodiments, instead of being a random value, the context information may be an encrypted value of a context identifier. A proper encryption, such as AES, produces evenly distributed values, which thus fulfils properties of a random value when generating an UUID. In this approach, the key is advantageously kept in secret. In a further embodiment, the context information may contain at least part of the context settings. When the context information is received, the key is used to decode the context information.

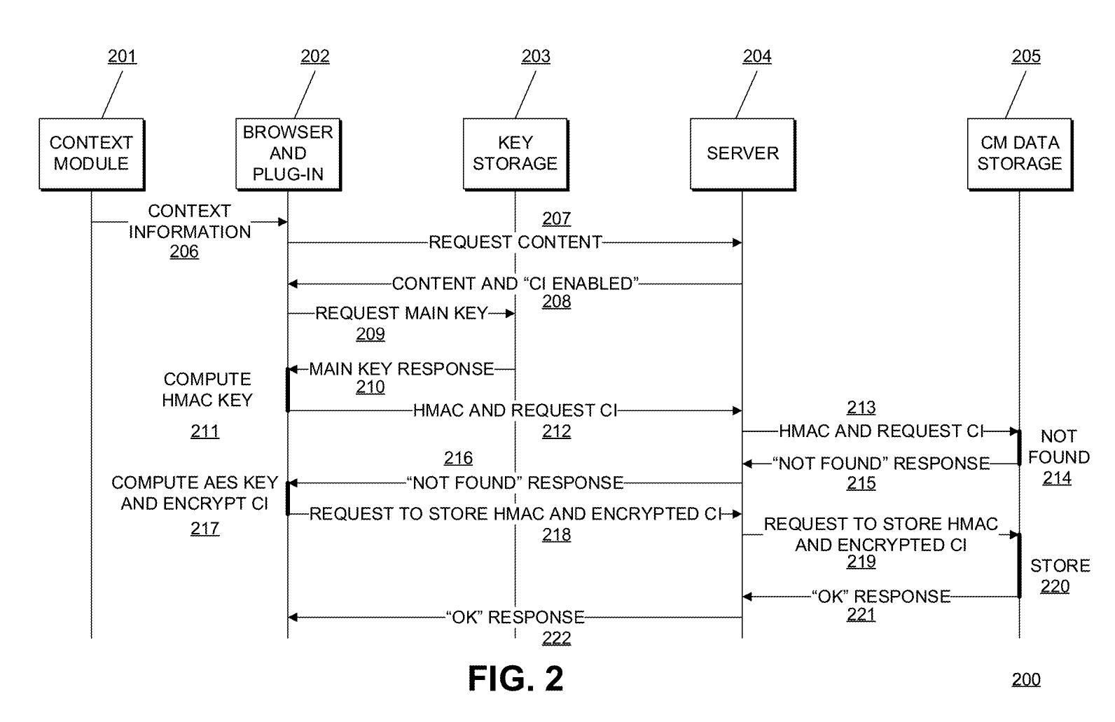

FIG. 2 is an exemplary sequence diagram 200 illustrating communication between a user device and a server 204 when context information for the user is not found on the server 204 and thus is provided to the server. A context information message 206 is sent by a context module 201 to a browser 202, which may be a browser equipped with plug-in software. The browser 202 sends a request content message 207 to a server 204. The server 204 responds to the browser 202 with the content and a “content information (CI) enabled” response 208. The browser 202 sends a main key request 209 to the key storage 203. The key storage 203 responds to the browser 202 with the main key 210. An HMAC key is computed 211. The browser 202 sends an HMAC with a CI request 212 to the server 204. The server 204 sends the HMAC with a CI request 213 to a CM data storage 205. For this example, the CM data storage 205 determines that the CI is not found 214. The CM data storage 205 responds with a “Not found” message 215 to the server 204. The server 204 forwards this message 216 to the browser 202. An AES key is computed to encrypt a CI 217. The browser 202 sends a request to store the HMAC and encrypted CI 218 to the server 204. The server 204 sends a request to store the HMAC and encrypted CI 219 to the CM data storage 205. The CM data storage 205 then stores the HMAC and encrypted CI 220. The CM data storage 205 replies to the server 204 with an “OK” acknowledgment response 221. The server 204 sends an “OK” acknowledgement response 222 to the browser and plug-in 202.

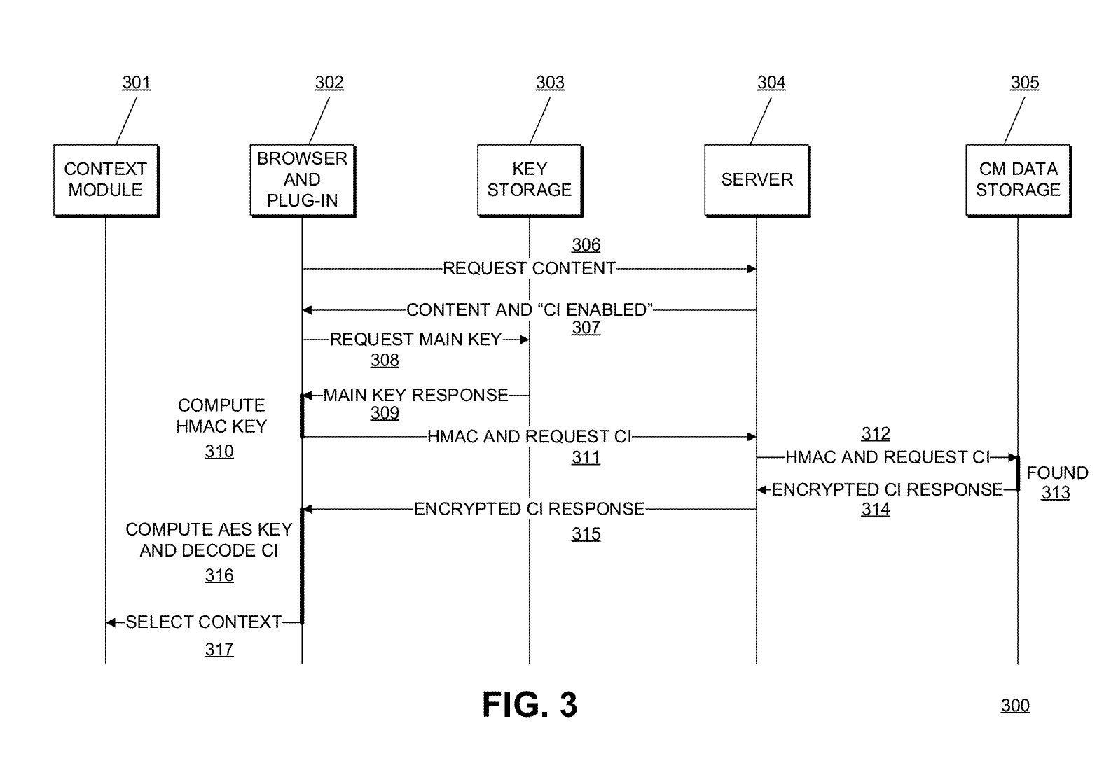

FIG. 3 is an exemplary sequence diagram 300 illustrating communication between a user device and a server 304 when context information is found on the server 304 and thus is provided by the server 304 to the user device. A browser 302, which may be a browser equipped with a plug-in, sends a content request 306 to a server 304. The server 304 responds with the content and a “CI enabled” message 307. The browser 302 sends a main key request 308 to a key storage 303. The main key storage 303 responds with the main key 309. An HMAC key is computed 310. The browser 302 sends the HMAC with a CI request 311 to a server 304. The server 304 sends the HMAC with a CI request 312 to the CM data storage 305. The CM data storage 305 finds the HMAC 313 and replies to the server 304 with an encrypted CI message 314. The server 304 sends the encrypted CI message 315 to the browser 302. An AES key is computed and the CI message is decoded 316. The browser and plug-in 302 sends the context module 301 a select context message 317.

In both the FIG. 2 and FIG. 3 examples, the service announces being “context information enabled,” triggering the rest of the process. Also in both examples, context information is encrypted.

Both FIG. 2 and FIG. 3 illustrate embodiments in which the server manifests itself of being context information enabled, for instance by providing a HTML or XML tag, as described later. In some embodiments, if the service is context information enabled and the server does not yet have context information from the user (“not found” in FIG. 2), the user may be prompted to define a context for the service. This message sequence typically occurs at the first visit to the service.

In some embodiments, the key used to encode context information (“AES key”) and the key used in HMAC (“HMAC key”) are derived from a stored main key. Thus, the user may provide only one key, but both purposes have their own independent keys, making an attack less viable.

Instead of using a personal repository, the secret (main) key(s) may be stored in and distributed to all personal devices by other means, such as over a Bluetooth connection or NFC, or even calculating the secret key(s) from a passphrase entered to each device manually.

For illustrative purposes, an exemplary user may be a casual gambler. When he is using an online poker service from his tablet, he activates the “MyPoker” context, ensuring that all that happens during that session does not leak to other contexts. From the perspective of other contexts, the user now appears to be in a private browsing mode. However, session data and history data may be stored by the “MyPoker” context, allowing information to be saved and retrieved from one gambling session to the next. “MyPoker” context settings are associated with “MyPoker” context information, and the association is stored to the common repository.

In this example, when the user accesses the online poker service, the browser detects the tag that the service is context enabled and calculates the personal UUID using a HMAC from the poker service domain, using a secret key as described above. The browser plug-in requests context information related to the UUID. If the service returns previously stored context information, the previously stored context information may be compared with the current context. To make sure that all personal data is processed appropriately, the user may resolve a conflict, if a conflict exists. If there is no context information on the service, current context information is sent to the poker service, and the service stores it. At a later time, the user may again visit the poker website without selecting a context. On this subsequent visit (either with the same user device or with a different device associated with the same user), the user receives context information from the poker website, and the user's computing device automatically activates the “MyPoker” context, using the corresponding context settings. In some embodiments, when the session is over, the browser plug-in restores the previous session, as if no “MyPoker” context had been used (e.g., as if the user had been conducting a private browsing session).

### Contexts.

The use of contexts in exemplary embodiments may be understood with reference to examples described herein. For example, in some embodiments, personal data stored on a user device may be associated with one or more contexts. The personal data may include information on the user's physical identity (e.g., name and address), information on accounts and passwords of the user, information on the user's preferences and browsing history, HTTP cookies, photographs, notes, documents, and other information, without limitation. Software applications on the device may further be associated with one or more contexts.

In some embodiments, one or more tables are stored on the user device, with each row of a table providing associations between an element of personal data and a context, or between a software application and a context. Using this or other techniques, different contexts may thus have different associated data permissions.

In some embodiments, an operating system may allow a software program to read and write only data that is associated with a currently-active context. For example, a user device may include a plurality of different browser history files, with each browser history file being associated with a different context, such that when a particular context is active, a web browser stores browsing history information only to the history file associated with that context. The user device may further include different web cookie directories for storing HTTP cookies associated with different contexts. In such an embodiment, a web browser may retrieve and store cookie information only to and from the web cookie directory associated with the currently active context.

In some embodiments, only software associated with the currently active context are permitted to be operated. For example, if a gambling application is associated with the “MyPoker” context, the user may be unable to open that application when the “MyWork” context is active. Some applications, either by default or in response to a user selection, may be operable in multiple different contexts.

In some embodiments, the user interface of the user device is different for different contexts. For example, in a particular context, icons representing the most-used applications in that context may be automatically arranged in the most prominent position, or the user may select different arrangements of icons for different contexts. Different backgrounds or other visual cues may be provided for different contexts. Different icon sizes may be used in different contexts, for example with sports or outdoor-related contexts having greater icon sizes than contexts associated with, for example, work at a desk.

### Context Modules.

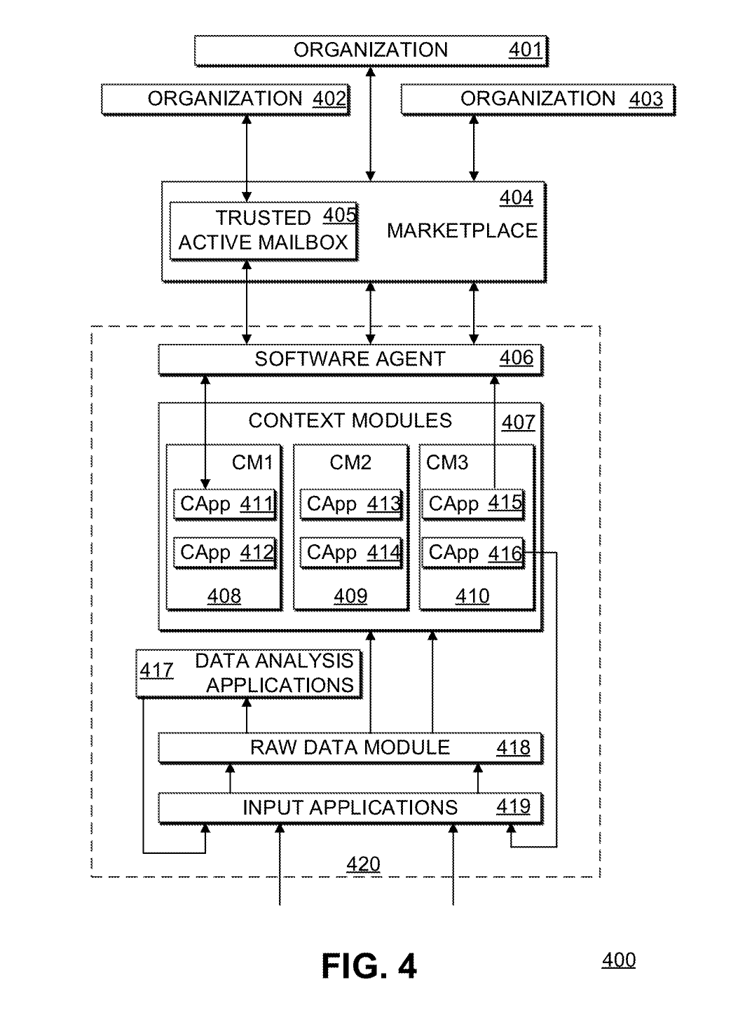

In some embodiments, different contexts are associated with different context modules in an ID Broker system architecture. FIG. 4 depicts an example ID Broker system architecture 400 in accordance with embodiments described herein. The ID Broker system architecture 400 depicted in FIG. 4 illustrates a system in which individuals and organizations communicate with one another. In particular, FIG. 4 depicts a set of organizations 401, 402, 403 in communication with a trusted intermediary referred to herein as a marketplace 404, with a WTRU of a user 420 (depicted within the dotted outline) being in communication with the marketplace 404.

The marketplace 404 may include a set of anonymous ad-hoc mailboxes (or trusted active mailboxes 405). The marketplace 404 and the included anonymous ad-hoc mailboxes 405 are in communication with a software-based user agent referred to herein as the software agent 406. The system architecture 400 further includes a set of context modules 407 (CM1 408, CM2 409, CM3 410), each context module 408, 409, 410 including a respective set of context applications (CApps) 411, 412, 413, 414, 415, 416. Context modules 407 may be virtual machines or other mechanisms used to provide data security and integrity, for example by allowing only limited intercommunication between applications in different context modules.

The marketplace 404 may receive data from various context module applications. Additionally, the software agent 406 may communicate with the various context module applications 411, 412, 413, 414, 415, 416. The system architecture 400 further includes respective sets of data analysis applications 417, raw data modules (common repositories) 418, and input applications 419. The set of input applications 419 may receive data from the set of data analysis applications 417, the set of context applications 411, 412, 413, 414, 415, 416, as well as various other sources (e.g., public and private compiled data sets and census data) as would be known by those with skill in the relevant art. The raw data module 418 receives data from the set of input applications 419. The raw data module 418 outputs data to the set of data analysis applications 417 as well as to the set of context modules 407. Each context application 411, 412, 413, 414, 415, 416 may make use of data sent as input to its corresponding context module 408, 409, 410.

In an embodiment, individuals receive offers from organizations for personal data. Individuals have the option to monetize access to their personal data in a way they deem suitable. Each user's personal software agent 406 acts on behalf of the user and send the user's personal data to a requesting organization. The user, through the software agent 406, may use some form or guarantee of compensation from the requesting organization before granting the requesting organization 401, 402, 403 access to the user's personal data. At least one mechanism that is supported by the architecture 400 depicted in FIG. 4 is to send targeted recommendations and advertisements from organizations 401, 402, 403 to individuals.

The system architecture 400 depicted in FIG. 4 may also be used for various statistical purposes. For example, an organization in the set of organizations 401, 402, 403 may want to calculate an average value of a numerical property from individuals who satisfy a certain criterion. As a specific example, the organization 401, 402, 403 may want to check an average income of a certain population group living in a certain geographical area using a certain sample size, e.g. N=200. The organization may write a query (using, e.g., SQL or other query language) to mine the data. A query reply contains information that may be generalized. For example, specific age values may be generalized to an age range, such as 20-30 or 30-40.

In some instances, a user's personal software agent 406 may enforce one or more rules that restrict providing exact information, such as exact “income age” information to the organization 401, 402, 403, as the inclusion of exact age and exact income may be used by a malicious organization to identify the user as a member of a group matching to the criteria. Because the malicious organization has access to public records (e.g., census data and tax information), this information may be used to identify the individual. If the match criterion is something that an individual does not want to be publicly known, there exists an anonymization and privacy problem.

In some embodiments, an individual associated with a software agent 406 may communicate with an organization 401, 402, 403 using a system referred to herein as an anonymous ad-hoc mailbox. In some embodiments, an anonymous ad-hoc mailbox resides in the marketplace 404. Individuals represented by a software agent 406, as well as organizations seeking data, have a certified public/private RSA key pair. An organization 401, 402, 403 running a campaign publishes the campaign in the marketplace 404. A user's software agent 406 compares the published information regarding the campaign with predetermined criteria set by the user to determine whether the user is willing to participate in the campaign. The software agent 406 further determines whether the user matches the published criteria for the campaign sends a signed and encrypted reply to an anonymous ad-hoc mailbox. However, as a result of this signed and encrypted reply, an organization may get too detailed information about individuals replying to the campaign e.g., exact “income age” information. Consequently, embodiments disclosed herein employ an active trusted element that is able to perform statistical calculations (e.g., average value) on data received at an anonymous ad-hoc mailbox. Such an active element is preferably located in a user-organization neutral zone. An anonymous ad-hoc mailbox provides communication services for network nodes having intermittent network access. The anonymous ad-hoc mailbox is a static data transfer service that may be protected by encryption.

### Exemplary Method.

An exemplary embodiment of a user device 420 operates according to methods described as follows. In the following description, the service being accessed is described as a web site, although other embodiments are operable using different types of online services.

In an exemplary embodiment, a user selects a URL of a web page, for example by entering the URL in an address bar or by clicking on a hyperlink. In response, the user's web browser sends a conventional HTTP GET or POST request to the appropriate server to access the linked content. When the content is received, the user's web browser (using, e.g., native browser functionality or a plug-in application) determines whether the content includes a tag, such as an HTML or XML tag or other indicator, indicating that the web site is context-information enabled. If the user device receives an indication that the web site is context-information enabled, the user device sends a request for context information to the server. In this exemplary embodiment, the request includes information identifying the user. The information identifying the user may be an identifier of the user that is persistent across different user devices accessed by that same user. As described in greater detail above, the request for context information may be sent using a keyed-hash message authentication code (HMAC).

The user device 420 receives a context-information response from the server. The context-information response may include context information that identifies a context, or the response may include an indication that no previously-stored context information is available.

If the user device 420 receives an indication that no previously-stored context information is available, the user device may send a context reporting message to the server identifying a context, which the server may store for later retrieval during future interactions with the user. This context information may be encrypted, with a decryption key held only by the user, or arbitrary identifiers may be used to identify different contexts, such that the server is unable to determine from the context information what context the user is in. The user device 420 may operate in different ways to determine which context to identify in the context reporting message. For example, in one embodiment, the user device automatically identifies the device's currently-active context. In another embodiment, the user device prompts the user as to which context to identify. In a further embodiment, the user device provides the user with a prompt indicating that the currently-active context will be reported unless the user selects otherwise.

If the user device 420 receives a context-information response that does include context information that identifies a context, the user device may operate in various different ways. In one embodiment, the user device automatically switches into the context identified in the context reporting message. In another embodiment, the user device 420 provides a prompt indicating to the user that the web site being visited is associated with a different context and providing the user the option of whether or not to switch to the new context. If the user has two or more tabs or windows open accessing different web sites associated with different contexts, the user may be warned of a potential conflict and may be provided with the opportunity to resolve the conflict by selecting one of the contexts. In some embodiments, the device may switch between the contexts depending on which of the web sites is in the foreground.

Once the user switches to a different context, the user device 420 operates to store and retrieve data differently. For example, the user's browsing history will be stored in a history file associated with the new context, and locally-stored account and session information (e.g., HTTP cookies) will be written to and read from data storage associated with the new context.

In some embodiments, when the user stops using a service associated with a context, the user device 420 may return to the previous context. For example, when a context is switched in response to a context identified by a web site, the user device 420 may store the previous context. The user device 420 may detect that the user has navigated away from the web site or has closed a tab or window in which that web site was displayed. In response to detecting that the user has stopped using the service, the user device switches to the previously-stored context. The switching to the previously-stored context may be performed automatically, or a user may be prompted as to whether to retain the current context or to revert to the previous context.

The user device 420 may take additional data-protective steps in response to a change of context. For example, web navigation actions by the user (e.g., entering an address or clicking a link) may not be recorded in a browsing history file until after the user device 420 determines the appropriate context for the web site. In an exemplary embodiment, when the user navigates to a web site, the user device 420 checks for an indication from the web site of whether the web site is context-information enabled. If the web site is not context-information enabled, the navigation action is recorded in a browsing history file associated with the currently active context. Similarly, if the web site is context-information enabled and if the web site provides a context identification response that identifies the already-active context, the navigation action is recorded in a browsing history file associated with the currently active context. However, if the web site is context-information enabled and provides a context identification response that identifies a new context, and if the user device switches to the new context, the navigation action is recorded in a browsing history file associated with the new context, as are subsequent navigation actions. In some embodiments, the context settings may also disable writing any history.

Similar protection may be afforded to HTTP cookies, which may be stored in different data locations (e.g., different directories) associated with different contexts. For example, the browser of a user device may wait to send HTTP cookie information to a web site until after the user device determines whether the web site will cause the device to switch to a new context. If the device does switch to the new context in response to visiting a web page, the browser may (automatically or after user approval) reload the web page using a new HTTP request message that includes cookie information associated with the new context. Similarly, the user device may refrain from storing (except maybe in temporary storage, e.g., RAM) any HTTP cookie received from the web site until the user device determines the relevant context for that web site. Once the relevant context is determined, the received cookie information may be stored in a directory or other location associated with that context.

Because context information is stored by one or more servers (e.g. web servers), automatic context switching may be accomplished even on user devices that have not previously connected to a particular networked service. For example, a user may use his laptop computer to visit a particular gaming web site while in the MyPoker context. The web site stores information (indexed by an appropriate user identifier) indicating that, for this particular user, the MyPoker context may be active while the web site is in use. (Though as described above, this stored information may be indecipherable to the web site itself) The user may visit the same web site, this time using a new device such as a smartphone or a notebook computer. Based on user identification information sent from the new device, the web site returns information indicating that the device may switch to the MyPoker context. The new device automatically (or with user approval) switches to the MyPoker context, even though the user may not have visited that web site using that particular device. Different contexts are associated with different data permissions, such that, for example, a browsing history and HTTP cookies stored while the user is in the MyPoker context may not be accessible when the user is in a different context (e.g. a work-related context).

### Hardware.

Note that various hardware elements of one or more of the described embodiments are referred to as “modules” that carry out (for example, perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and those instructions may take the form of or include hardware (for example, hardwired) instructions, firmware instructions, software instructions, and/or the like, and may be stored in any suitable non-transitory computer-readable medium or media, such as commonly referred to as RAM and ROM.

Exemplary embodiments disclosed herein are implemented using one or more wired and/or wireless network nodes, such as a wireless transmit/receive unit (WTRU) or other network entity.

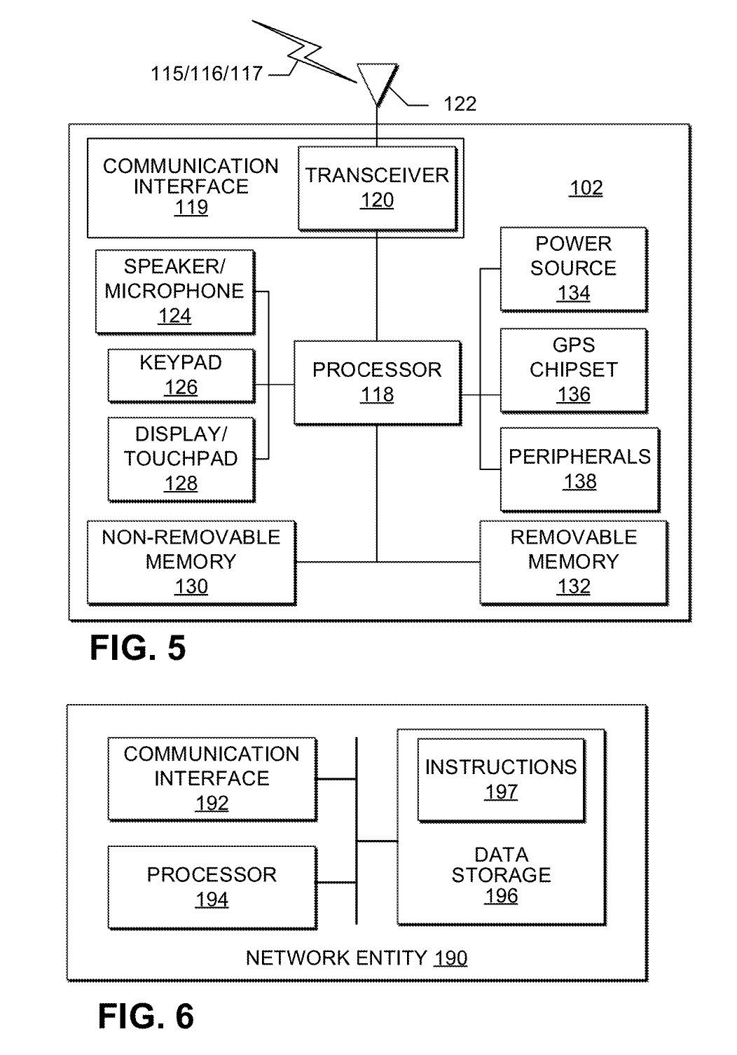

FIG. 5 is a system diagram of an exemplary WTRU 102, which may be employed as a user device in embodiments described herein. As shown in FIG. 5, the WTRU 102 may include a processor 118, a communication interface 119 including a transceiver 120, a transmit/receive element 122, a speaker/microphone 124, a keypad 126, a display/touchpad 128, a non-removable memory 130, a removable memory 132, a power source 134, a global positioning system (GPS) chipset 136, and sensors 138. The WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 5 depicts the processor 118 and the transceiver 120 as separate components, the processor 118 and the transceiver 120 may be integrated together in an electronic package or chip.

The transmit/receive element 122 may be configured to transmit signals to, or receive signals from, a base station over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 5 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 6 depicts an exemplary network entity 190 that may be used in embodiments of the present specification, for example as a networked service provider, such as a web server. As depicted in FIG. 6, network entity 190 includes a communication interface 192, a processor 194, and non-transitory data storage 196, all of which are communicatively linked by a bus, network, or other communication path 198.

Communication interface 192 may include one or more wired communication interfaces and/or one or more wireless-communication interfaces. With respect to wired communication, communication interface 192 may include one or more interfaces such as Ethernet interfaces, as an example. With respect to wireless communication, communication interface 192 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 192 may be equipped at a scale and with a configuration appropriate for acting on the network side—as opposed to the client side—of wireless communications (e.g., LTE communications, Wi-Fi communications, and the like). Thus, communication interface 192 may include the appropriate equipment and circuitry (perhaps including multiple transceivers) for serving multiple mobile stations, UEs, or other access terminals in a coverage area.

Processor 194 may include one or more processors of any type deemed suitable by those of skill in the relevant art, some examples including a general-purpose microprocessor and a dedicated DSP.

Data storage 196 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art may be used. As depicted in FIG. 6, data storage 196 contains program instructions 197 executable by processor 194 for carrying out various combinations of the various network-entity functions described herein.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
accessing a first networked service with a first user device currently in a first context, wherein accessing includes sending, to the first networked service, a user identifier;
in response to accessing the first networked service, receiving context information identifying a second context, wherein the second context is different from the first context, from the first networked service at the first user device;
in response to receiving the context information, switching the context of the first user device from the first context to the second context identified in the received context information, wherein the first and second contexts are respectively associated with different first and second data access permissions; and
after switching the first user device to the second context, storing information regarding interactions with the first networked service with the second data permissions associated with the second context, the first and second data access permissions being different.

2. The method of claim 1, wherein accessing the first networked service using the first user device further comprises:
receiving, from the first networked service, an indication that the first networked service is a context-information enabled networked service; and
requesting, from the first networked service, based on the indication, any previously stored context information relating to the user identifier.

3. The method of claim 1, wherein the context information received from the first networked service and identifying the second context is encrypted, and wherein a decryption key to decrypt the encrypted context information is held at least by the first user device and not the first networked service.

4. (canceled)

5. The method of claim 1, wherein the context information identifying the second context comprises context information previously stored with the first networked service.

6. The method of claim 1, wherein the first networked service comprises a first website, and wherein the information regarding interactions with the first networked service includes a browser history and HTTP cookies from the first networked service.

7. The method of claim 1, wherein a set of personal data associated with each context is accessible only in that respective context.

8. The method of claim 1, wherein switching the context of the first user device from the first context to the second context is automatically performed.

9. The method of claim 1, wherein switching the context of the first user device from the first context to the second context is performed only after obtaining user confirmation.

10. (canceled)

11. The method of claim 1, further comprising:
determining that a second networked service is a context-information enabled networked service;
determining that the second networked service does not have any previously stored context information regarding a user of the first user device; and
reporting encrypted context information associated with the first context and an encrypted user identifier to the second networked service for use during a current and future session with the user.

12. The system of claim 15, wherein the context information identifying the second context comprises context information previously stored with the first networked service.

13. The system of claim 15, wherein switching the context of the first user device from the first context to the second context is automatically performed.

14. The system of claim 15, wherein switching the context of the first user device from the first context to the second context is performed only after obtaining user confirmation.

15. An apparatus comprising a processor and a non-transitory computer-readable medium storing instructions that are operative, when executed on the processor, to perform functions comprising:
accessing a first networked service with a first user device currently in a first context, wherein accessing includes sending, to the first networked service, a user identifier;
in response to accessing the first networked service, receiving context information identifying a second context, wherein the second context is different from the first context, from the first networked service at the first user device;
in response to receiving the context information, switching the context of the first user device from the first context to the second context identified in the received context information, wherein the first and second contexts are respectively associated with different first and second data access permissions; and
after switching the first user device to the second context, storing information regarding interactions with the first networked service with the second data permissions associated with the second context, the first and second data access permissions being different.

16. The system of claim 15, wherein accessing the first networked service using the first user device further comprises:
receiving, from the first networked service, an indication that the first networked service is a context-information enabled networked service; and
requesting, from the first networked service, based on the indication, any previously stored context information relating to the user identifier.

17. The system of claim 15, wherein the context information received from the first networked service and identifying the second context is encrypted, and wherein a decryption key to decrypt the encrypted context information is held at least by the first user device and not the first networked service.

18. The method of claim 1, comprising:
requesting content from a second networked service using the first user device;
receiving, from the second networked service, an indication that the second networked service is a context-information enabled networked service;
requesting, from the second networked service, based on the indication, any previously stored context information associated with the user identifier;
receiving an indication, from the second networked service, that no previously stored context information is available from the second networked service; and
sending a context reporting message to the second networked service to be stored for retrieval in subsequent interactions with the user, the content reporting message comprising encrypted context information associated with the user identifier and a context of the first user device when the context reporting message is sent.

19. The method of claim 1, wherein accessing the first networked service using the first user device further comprises:
sending the user identifier to the first networked service only after receiving, from the first networked service, an indication that the first networked service is a context-information enabled networked service.

20. The method of claim 1, wherein the user identifier is uniquely associated with a user of the first user device, and wherein the context information identifying the second context comprises context information previously stored with the first networked service during a prior access of the first networked service, by at least one of the first user device or a second user device associated with the user of the first user device.

21. The method of claim 1, wherein the user identifier is uniquely associated with a user of the first user device, and wherein the context information received from the first networked service and identifying the second context is encrypted, and wherein a decryption key to decrypt the encrypted context information is held at least by the first user device and not the first networked service, such that a server of the first networked service is unable to determine from the encrypted context information the context of the user, and wherein the context information comprises an encrypted context information identifier.
